(19) United States
(12) Patent Application Publication
(10) Pub. No.: US 2026/0220737 A1
(43) Pub. Date: Jul. 30, 2026

(54) MULTI-LAYER IMAGE TRANSFORMATION FOR POINT OF VIEW CORRECTION

(71) Applicant: Apple Inc., Cupertino, CA (US)

(72) Inventors: Vincent Chapdelaine-Couture, Carignan (CA); Jean-Nicola F. Blanchet, Lachine (CA); Anthony Ghannoum, Monteal (CA)

(21) Appl. No.: 19/459,444

(22) Filed: Jan. 26, 2026

Related U.S. Application Data
(60) Provisional application No. 63/750,530, filed on Jan. 28, 2025.

(51) Int. Cl. G06T 3/18; G06T 3/4038; G06T 7/194

(52) U.S. Cl. CPC G06T 3/18; G06T 3/4038; G06T 7/194

(57) ABSTRACT

A method is performed at an electronic device including one or more processors, a non-transitory memory, an image sensor, and a display. The method includes capturing a current image of a physical environment from a current perspective of the image sensor. The method includes generating a plurality of classification maps based on an image matting function and a three-dimensional (3D) feature map associated with the physical environment. The method includes identifying, using the plurality of classification maps, a foreground region of the current image and a background region of the current image. The method includes transforming the foreground and background regions of the current image based on a difference between the current perspective of the image sensor and a current perspective of a user of the electronic device. The method includes displaying the transformed image on the display.

### CROSS-REFERENCES TO RELATED APPLICATIONS

This application claims priority to U.S. Provisional Patent App. No. 63/750,530, filed on January 28, 2025, which is hereby incorporated by reference in its entirety.

### TECHNICAL FIELD

The present disclosure relates to systems, methods, and devices of transforming an image of a physical environment for point of view correction.

### BACKGROUND

In various circumstances, for a head-mountable device (HMD) with a display and an image sensor, the HMD captures, via the image sensor, an image of a physical environment, and displays the image to a user wearing the HMD. However, the displayed image often does not reflect what the user would see were the user not wearing the HMD. This disparity may be due to different relative positions of an eye of the user, the display, and the image sensor in physical space, resulting in poor distance perception, disorientation of the user, and poor hand-eye coordination (e.g., while interacting with the physical environment).

### SUMMARY

In accordance with some implementations, a method is performed at an electronic device including one or more processors, a non-transitory memory, an image sensor, and a display. The method includes capturing a current image of a physical environment from a current perspective of the image sensor. The method includes generating a plurality of classification maps based on an image matting function and a three-dimensional (3D) feature map associated with the physical environment. The method includes identifying, using the plurality of classification maps, a foreground region of the current image and a background region of the current image. The method includes transforming the foreground and background regions of the current image based on a difference between the current perspective of the image sensor and a current perspective of a user of the electronic device. The method includes displaying the transformed image on the display.

In accordance with some implementations, a method is performed at an electronic device including one or more processors, a non-transitory memory, an image sensor, and a display. The method includes capturing a current image of a physical environment from a first perspective of the image sensor. The method includes generating a transformed image by transforming the current image to a second perspective different from the first perspective. The transforming includes segmenting the current image into first and second layers based on depth information regarding the physical environment, warping the first layer to generate a first warped layer, and warping the second layer to generate a second warped layer, and blending the first warped layer with the second warped layer. The method includes displaying the transformed image on the display.

In accordance with some implementations, an electronic device includes one or more processors, a non-transitory memory, and a display. One or more programs are stored in the non-transitory memory and are configured to be executed by the one or more processors. The one or more programs include instructions for performing or causing performance of the operations of any of the methods described herein. In accordance with some implementations, a non-transitory computer readable storage medium has stored therein instructions which when executed by one or more processors of an electronic device, cause the device to perform or cause performance of the operations of any of the methods described herein. In accordance with some implementations, an electronic device includes means for performing or causing performance of the operations of any of the methods described herein. In accordance with some implementations, an information processing apparatus, for use in an electronic device, includes means for performing or causing performance of the operations of any of the methods described herein.

### BRIEF DESCRIPTION OF THE DRAWINGS

For a better understanding of the various described implementations, reference should be made to the Description, below, in conjunction with the following drawings in which like reference numerals refer to corresponding parts throughout the figures.

FIG. 1 is a block diagram of an example of a portable multifunction device in accordance with some implementations.

FIG. 2 is an example of an operating environment in accordance with some implementations.

FIGS. 3A-3E are an example of an electronic device generating classification maps according to various implementations.

FIG. 4 is an example of an electronic device that is configured to perform multi-layer image warping in accordance with some implementations.

FIG. 5 is an example scenario related to capturing an image of physical environment and displaying the captured image in accordance with some implementations.

FIG. 6 is a first example of a flow diagram of a method of performing multi-layer image transforming according to various implementations.

FIG. 7 is a second example of a flow diagram of a method of performing multi-layer image transforming according to various implementations.

### DESCRIPTION OF IMPLEMENTATIONS

In various circumstances, for a head-mountable device (HMD) with a display and an image sensor, images of the physical environment captured by the image sensor are displayed to a user. However, the displayed images often do not reflect what the user would see if the HMD were not present. This disparity may be due to different positions of the eyes, the display, and the image sensor in space, resulting in poor distance perception, disorientation of the user, and poor hand-eye coordination (e.g., while interacting with the physical environment). Certain techniques include transforming the image of the physical environment to make it appear as though it were captured at the same location as the eyes of the user (e.g., to make the captured image appear as though the user were viewing the physical environment while not wearing the HMD). However, these techniques are inadequate as there may be objects in the field-of-view of the eye that are not in the field-of-view of the image sensor. This results in holes, artifacts, and other types of distortion in the transformed image, especially in regions where a physical object occludes a portion of the field-of-view. Some techniques attempt to reduce the distortion by transforming the image of the physical environment based on a depth map of the physical environment. However, a depth map may provide a limited amount of depth information regarding the physical environment, resulting in a distorted transformed image. Moreover, transforming the image using a more detailed depth map results in higher computational costs and latency associated with processing the more detailed depth map.

By contrast, various implementations disclosed herein include methods, electronic devices, and systems for multi-layer transformation of a current image of a physical environment. To that end, in some implementations, a method includes segmenting the current image of the physical environment into layers based on depth information regarding the physical environment, warping the layers, and blending the warped layers to generate a transformed image for display. Segmenting the current image may be based on classification maps, respectively associated with the layers. For example, a first classification map indicates a foreground layer associated with the physical environment, and a second classification map indicates a background layer associated with the physical environment. To that end, in some implementations, the method includes generating the classification maps based on image matting function and a three-dimensional (3D) feature map associated with the physical environment. The 3D feature map may include a small amount of informational (e.g., low resolution), relative to the current image. Thus, generation of the classification maps is computationally inexpensive. In some implementations, the 3D feature map corresponds to an aggregation of two-dimensional (2D) feature maps previously projected into 3D space. Each of the 2D feature maps may be associated with a different view (e.g., perspective) of a feature of the physical environment. For example, the feature may correspond to an edge of physical laptop in the physical environment. In some implementations, the method includes identifying, using the classification maps, a foreground region of the current image and a background region of the current image, and transforming the foreground and background regions of the current image based on a difference between the current perspective of the image sensor and a current perspective of a user of the electronic device.

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described implementations. The first contact and the second contact are both contacts, but they are not the same contact, unless the context clearly indicates otherwise.

The terminology used in the description of the various described implementations herein is for the purpose of describing particular implementations only and is not intended to be limiting. As used in the description of the various described implementations and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes”, “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting”, depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]”, depending on the context.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person’s physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person’s eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person’s eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person’s retina. Projection systems also may be configured to project virtual objects into the physical environment, for example, as a hologram or on a physical surface.

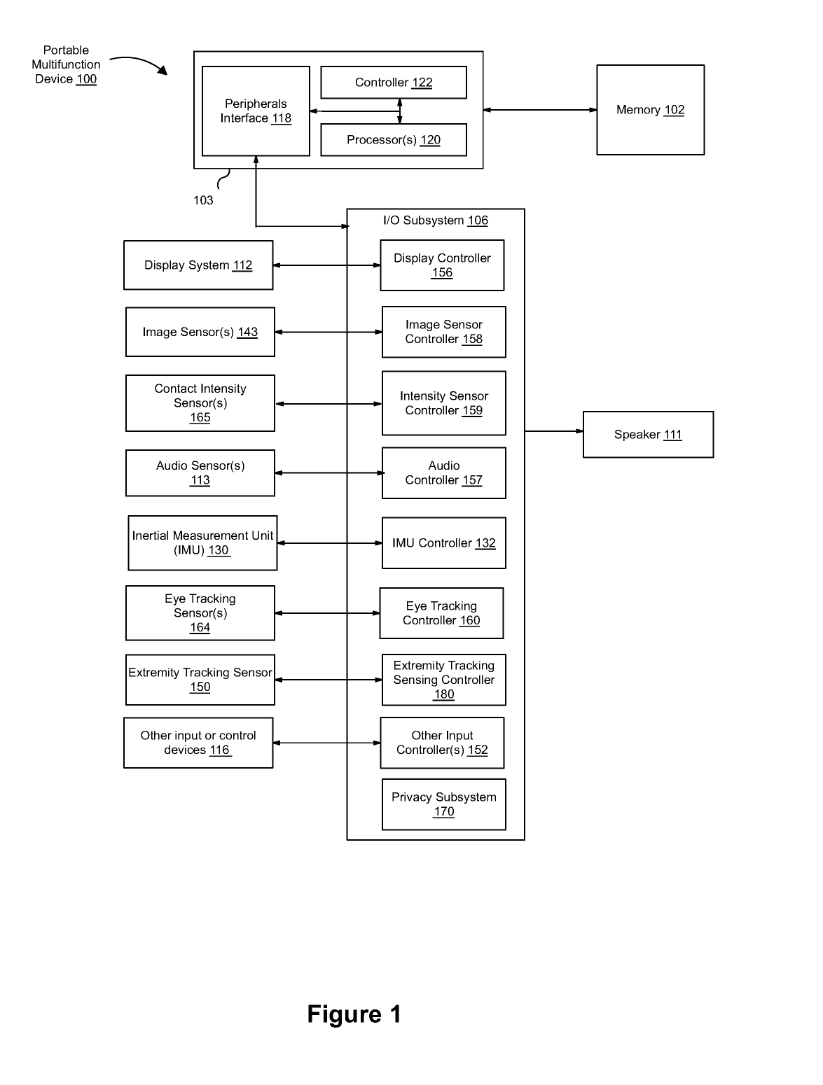

FIG. 1 is a block diagram of an example of a portable multifunction device 100 (sometimes also referred to herein as the “electronic device 100” for the sake of brevity) in accordance with some implementations. The electronic device 100 includes memory 102 (which optionally includes one or more computer readable storage mediums), a memory controller 122, one or more processing units (CPUs) 120, a peripherals interface 118, an input/output (I/O) subsystem 106, a speaker 111, a display system 112, an inertial measurement unit (IMU) 130, image sensor(s) 143 (e.g., camera), contact intensity sensor(s) 165, audio sensor(s) 113 (e.g., microphone), eye tracking sensor(s) 164 (e.g., included within a head-mountable device (HMD)), an extremity tracking sensor 150, and other input or control device(s) 116. In some implementations, the electronic device 100 corresponds to one of a mobile phone, tablet, laptop, wearable computing device, head-mountable device (HMD), head-mountable enclosure (e.g., the electronic device 100 slides into or otherwise attaches to a head-mountable enclosure), or the like. In some implementations, the head-mountable enclosure is shaped to form a receptacle for receiving the electronic device 100 with a display.

In some implementations, the peripherals interface 118, the one or more processing units 120, and the memory controller 122 are, optionally, implemented on a single chip, such as a chip 103. In some other implementations, they are, optionally, implemented on separate chips.

The I/O subsystem 106 couples input/output peripherals on the electronic device 100, such as the display system 112 and the other input or control devices 116, with the peripherals interface 118. The I/O subsystem 106 optionally includes a display controller 156, an image sensor controller 158, an intensity sensor controller 159, an audio controller 157, an eye tracking controller 160, one or more input controllers 152 for other input or control devices, an IMU controller 132, an extremity tracking controller 180, and a privacy subsystem 170. The one or more input controllers 152 receive/send electrical signals from/to the other input or control devices 116. The other input or control devices 116 optionally include physical buttons (e.g., push buttons, rocker buttons, etc.), dials, slider switches, joysticks, click wheels, and so forth. In some alternate implementations, the one or more input controllers 152 are, optionally, coupled with any (or none) of the following: a keyboard, infrared port, Universal Serial Bus (USB) port, stylus, auxiliary device, and/or a pointer device such as a mouse. The one or more buttons optionally include an up/down button for volume control of the speaker 111 and/or audio sensor(s) 113. The one or more buttons optionally include a push button. In some implementations, the other input or control devices 116 includes a positional system (e.g., GPS) that obtains information concerning the location and/or orientation of the electronic device 100 relative to a particular object. In some implementations, the other input or control devices 116 include a depth sensor and/or a time of flight sensor that obtains depth information characterizing a particular object.

The display system 112 provides an input interface and an output interface between the electronic device 100 and a user. The display controller 156 receives and/or sends electrical signals from/to the display system 112. The display system 112 displays visual output to the user. The visual output optionally includes graphics, text, icons, video, and any combination thereof (collectively termed “graphics”). In some implementations, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

The display system 112 may have a touch-sensitive surface, sensor, or set of sensors that accepts input from the user based on haptic and/or tactile contact. The display system 112 and the display controller 156 (along with any associated systems and/or sets of instructions in the memory 102) detect contact (and any movement or breaking of the contact) on the display system 112 and converts the detected contact into interaction with user-interface objects (e.g., one or more soft keys, icons, web pages or images) that are displayed on the display system 112. In an example implementation, a point of contact between the display system 112 and the user corresponds to a finger of the user or an auxiliary device.

In some implementations, the display system 112 corresponds to a display integrated in a head-mountable device (HMD), such as AR glasses. For example, the display system 112 includes a stereo display (e.g., stereo pair display) that provides (e.g., mimics) stereoscopic vision for eyes of a user wearing the HMD.

The display system 112 optionally uses LCD (liquid crystal display) technology, LPD (light emitting polymer display) technology, or LED (light emitting diode) technology, although other display technologies are used in other implementations. The display system 112 and the display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with the display system 112.

The user optionally makes contact with the display system 112 using any suitable object or appendage, such as an auxiliary device, an extremity (e.g., a finger), and so forth. In some implementations, the user interface is designed to work with finger-based contacts and gestures, which can be less precise than stylus-based input due to the larger area of contact of a finger on the touch screen. In some implementations, the electronic device 100 translates the rough finger-based input into a precise pointer/cursor position or command for performing the actions desired by the user.

The speaker 111 and the audio sensor(s) 113 provide an audio interface between a user and the electronic device 100. Audio circuitry receives audio data from the peripherals interface 118, converts the audio data to an electrical signal, and transmits the electrical signal to the speaker 111. The speaker 111 converts the electrical signal to human-audible sound waves. Audio circuitry also receives electrical signals converted by the audio sensors 113 (e.g., a microphone) from sound waves. Audio circuitry converts the electrical signal to audio data and transmits the audio data to the peripherals interface 118 for processing. Audio data is, optionally, retrieved from and/or transmitted to the memory 102 and/or RF circuitry by the peripherals interface 118. In some implementations, audio circuitry also includes a headset jack. The headset jack provides an interface between audio circuitry and removable audio input/output peripherals, such as output-only headphones or a headset with both output (e.g., a headphone for one or both ears) and input (e.g., a microphone).

The inertial measurement unit (IMU) 130 includes accelerometers, gyroscopes, and/or magnetometers in order measure various forces, angular rates, and/or magnetic field information with respect to the electronic device 100. Accordingly, according to various implementations, the IMU 130 detects one or more positional change inputs of the electronic device 100, such as the electronic device 100 being shaken, rotated, moved in a particular direction, and/or the like.

The image sensor(s) 143 capture still images and/or video. In some implementations, an image sensor 143 is located on the back of the electronic device 100, opposite a touch screen on the front of the electronic device 100, so that the touch screen is enabled for use as a viewfinder for still and/or video image acquisition. In some implementations, another image sensor 143 is located on the front of the electronic device 100 so that the user's image is obtained (e.g., for selfies, for videoconferencing while the user views the other video conference participants on the touch screen, etc.). In some implementations, the image sensor(s) are integrated within an HMD.

The contact intensity sensors 165 detect intensity of contacts on the electronic device 100 (e.g., a touch input on a touch-sensitive surface of the electronic device 100). The contact intensity sensors 165 are coupled with the intensity sensor controller 159 in the I/O subsystem 106. The contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). The contact intensity sensor(s) 165 receive contact intensity information (e.g., pressure information or a proxy for pressure information) from the physical environment. In some implementations, at least one contact intensity sensor 165 is collocated with, or proximate to, a touch-sensitive surface of the electronic device 100. In some implementations, at least one contact intensity sensor 165 is located on the side of the electronic device 100.

The eye tracking sensor(s) 164 detect eye gaze of a user of the electronic device 100 and generate eye tracking data indicative of the eye gaze of the user. In various implementations, the eye tracking data includes data indicative of a fixation point (e.g., point of regard) of the user on a display panel, such as a display panel within a head-mountable device (HMD), a head-mountable enclosure, or within a heads-up display.

The extremity tracking sensor 150 obtains extremity tracking data indicative of a position of an extremity of a user. For example, in some implementations, the extremity tracking sensor 150 corresponds to a hand tracking sensor that obtains hand tracking data indicative of a position of a hand or a finger of a user within a particular object. In some implementations, the extremity tracking sensor 150 utilizes computer vision techniques to estimate the pose of the extremity based on camera images.

In various implementations, the electronic device 100 includes a privacy subsystem 170 that includes one or more privacy setting filters associated with user information, such as user information included in extremity tracking data, eye gaze data, and/or body position data associated with a user. In some implementations, the privacy subsystem 170 selectively prevents and/or limits the electronic device 100 or portions thereof from obtaining and/or transmitting the user information. To this end, the privacy subsystem 170 receives user preferences and/or selections from the user in response to prompting the user for the same. In some implementations, the privacy subsystem 170 prevents the electronic device 100 from obtaining and/or transmitting the user information unless and until the privacy subsystem 170 obtains informed consent from the user. In some implementations, the privacy subsystem 170 anonymizes (e.g., scrambles or obscures) certain types of user information. For example, the privacy subsystem 170 receives user inputs designating which types of user information the privacy subsystem 170 anonymizes. As another example, the privacy subsystem 170 anonymizes certain types of user information likely to include sensitive and/or identifying information, independent of user designation (e.g., automatically).

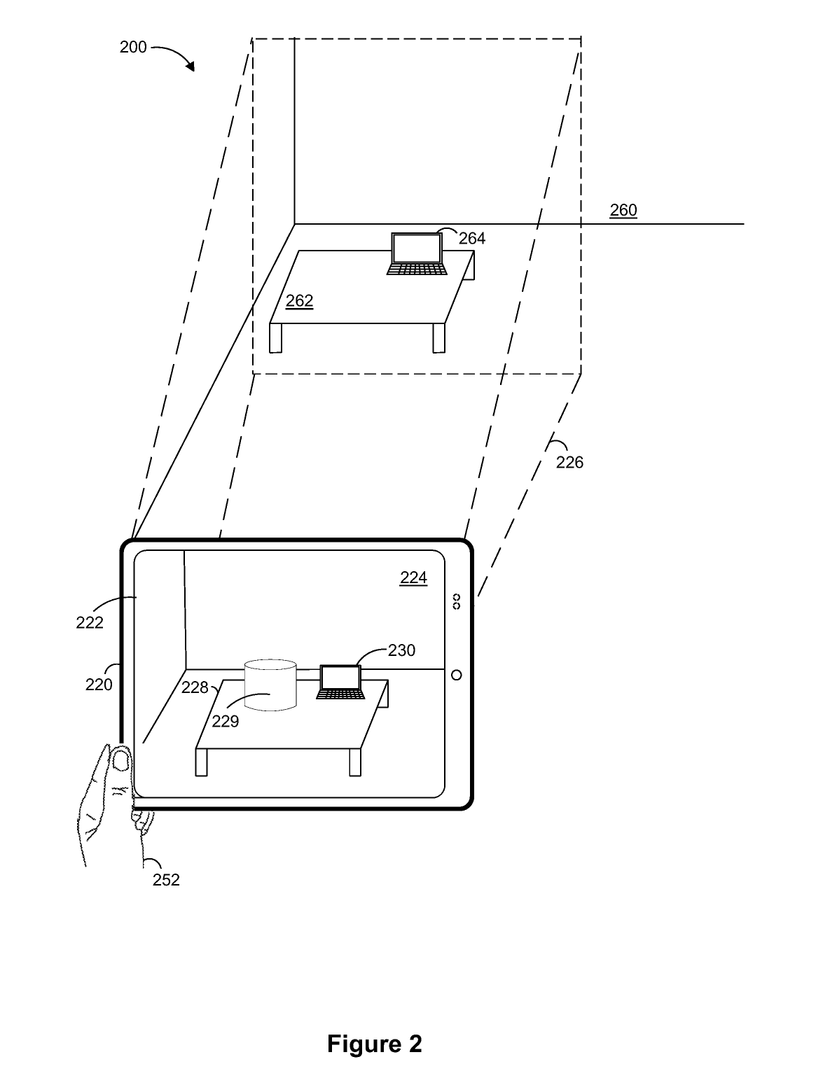

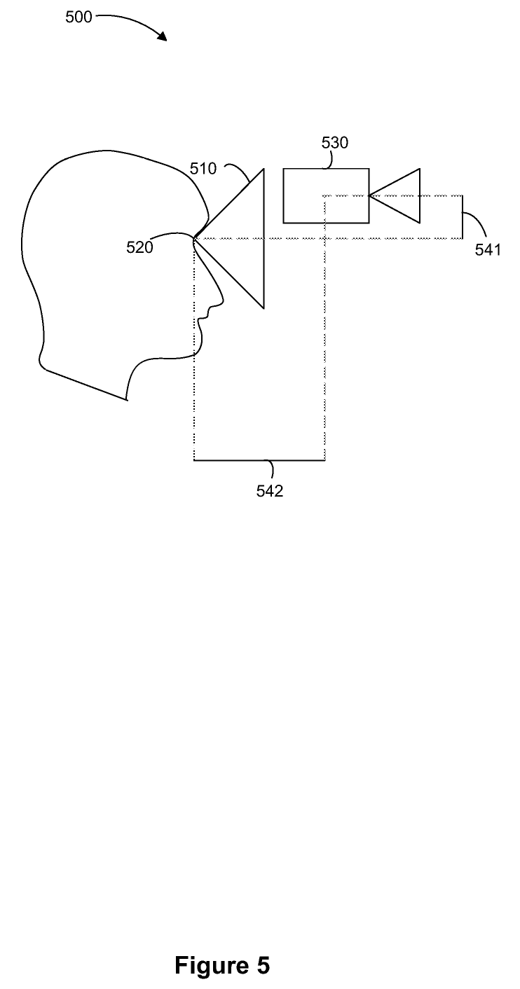

FIG. 2 is an example of an operating environment 200 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 200 includes a physical environment 260 and an electronic device 220 (e.g., the electronic device 100 of FIG. 1). The physical environment includes a physical table 262 and a physical laptop 264 resting on the physical table 262. As illustrated in FIG. 2, in some implementations, the electronic device 220 is being held by a left hand 252 of a user. In some implementations, the electronic device 220 corresponds to an HMD that includes an image sensor and a display (e.g., a built-in display) that displays a representation of the physical environment 260. As one example, FIG. 5 illustrates an example scenario 500 including an HMD being worn by a user. In some implementations, the electronic device 220 includes a head-mountable enclosure. In various implementations, the head-mountable enclosure includes an attachment region to which another device with a display can be attached. In various implementations, the head-mountable enclosure is shaped to form a receptacle for receiving another device that includes a display. For example, in some implementations, the electronic device 220 slides/snaps into or otherwise attaches to the head-mountable enclosure. In some implementations, the display of the device attached to the head-mountable enclosure presents (e.g., displays) the representation of the operating environment 200. For example, in some implementations, the electronic device 220 corresponds to a mobile phone that can be attached to the head-mountable enclosure.

Referring back to FIG. 2, the electronic device 220 includes a display 222 that is associated with a viewable region 226 of the physical environment. The viewable region 226 includes the includes a physical table 262 and the physical laptop 264. In some implementations, the electronic device 220 displays, on the display 222, a representation of the physical environment 260. For example, as illustrated in FIG. 2, the display 222 includes a representation 228 of the physical table 262 and a representation 230 of the physical laptop 264. In some implementations, the representation of the physical environment 260 corresponds to (e.g., pass-through) image data of the physical environment 260, captured by an image sensor of the electronic device 220. For example, the image data represents a sequence of images of the physical environment 260.

In some implementations, the electronic device 220 is configured to display computer-generated (e.g., virtual) content along with the representation of the physical environment 260. For example, in some implementations, the electronic device 220 is configured to present, on the display 222, a user interface (UI) and/or an XR environment 224 to the user. For example, as illustrated in FIG. 2, the computer-generated content includes a computer-generated (e.g., virtual) cylinder 229, which may be world-locked (e.g., anchored) to the representation 228 of the physical table 262.

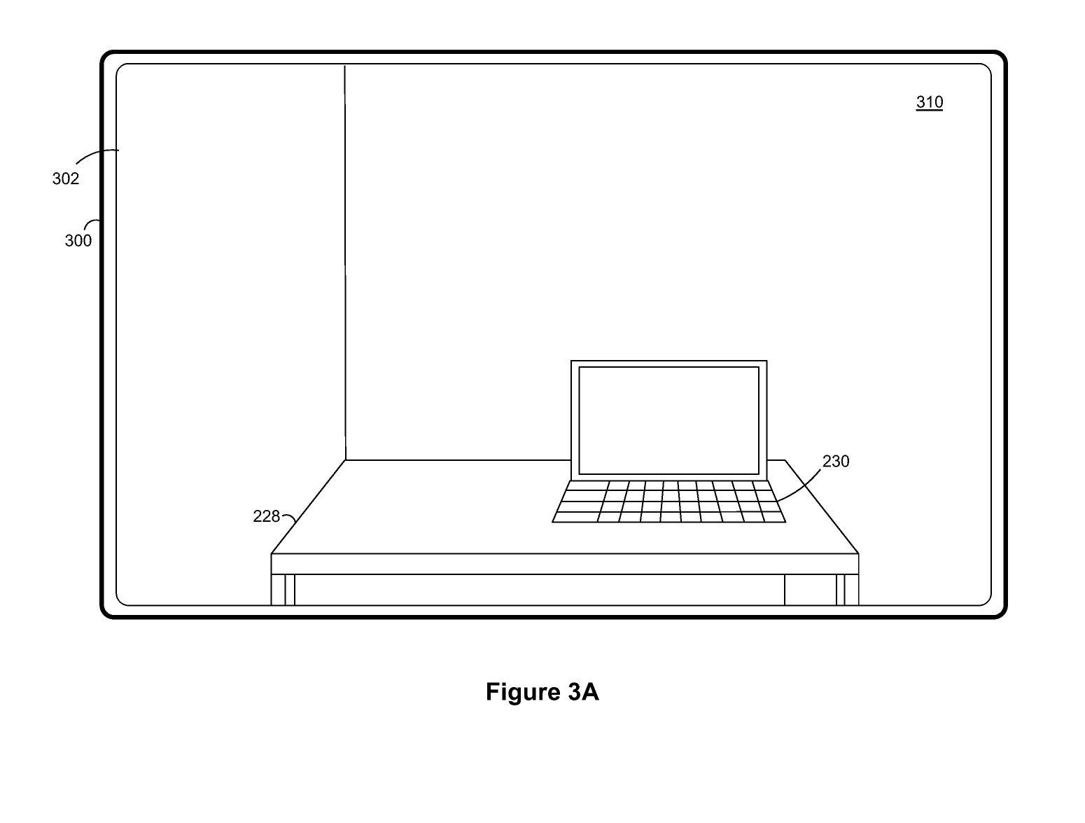

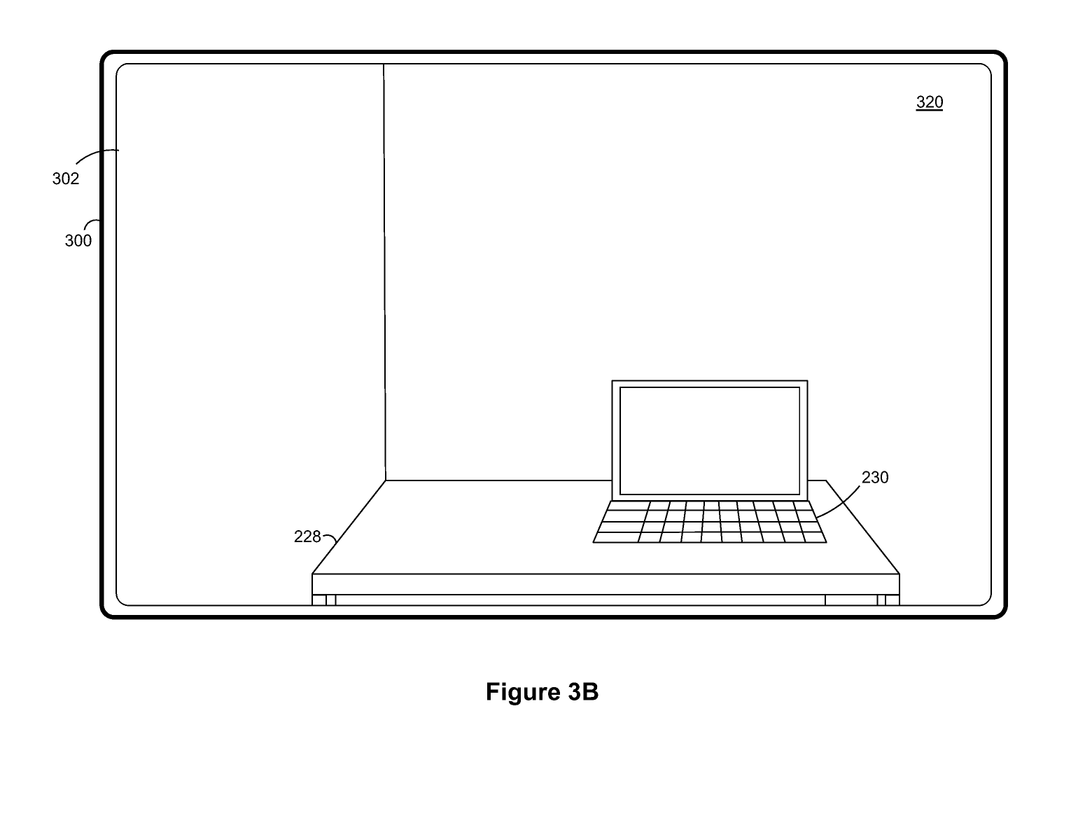

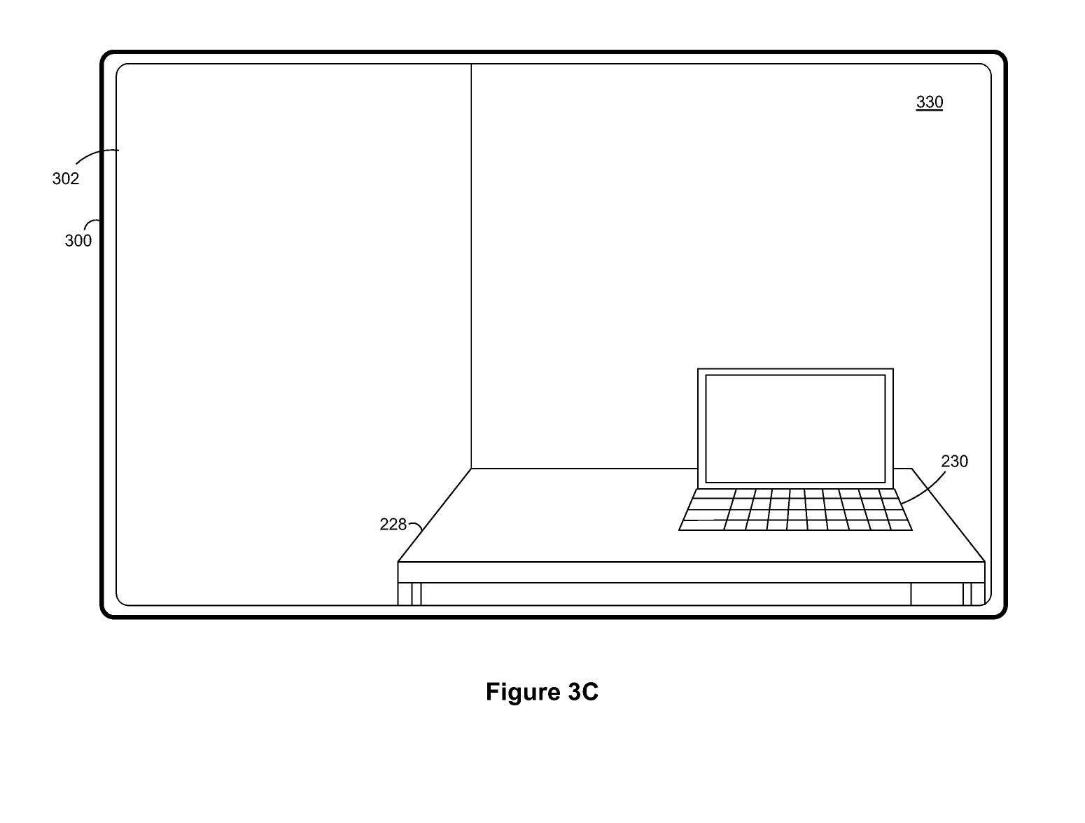

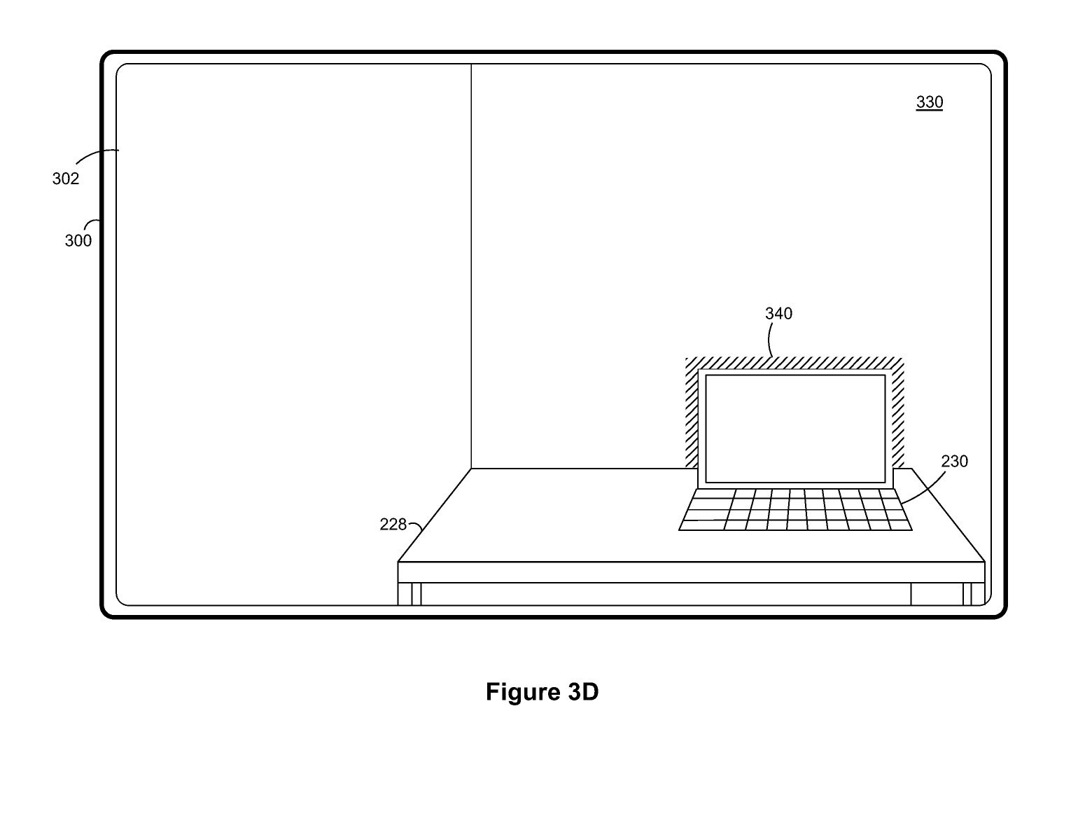

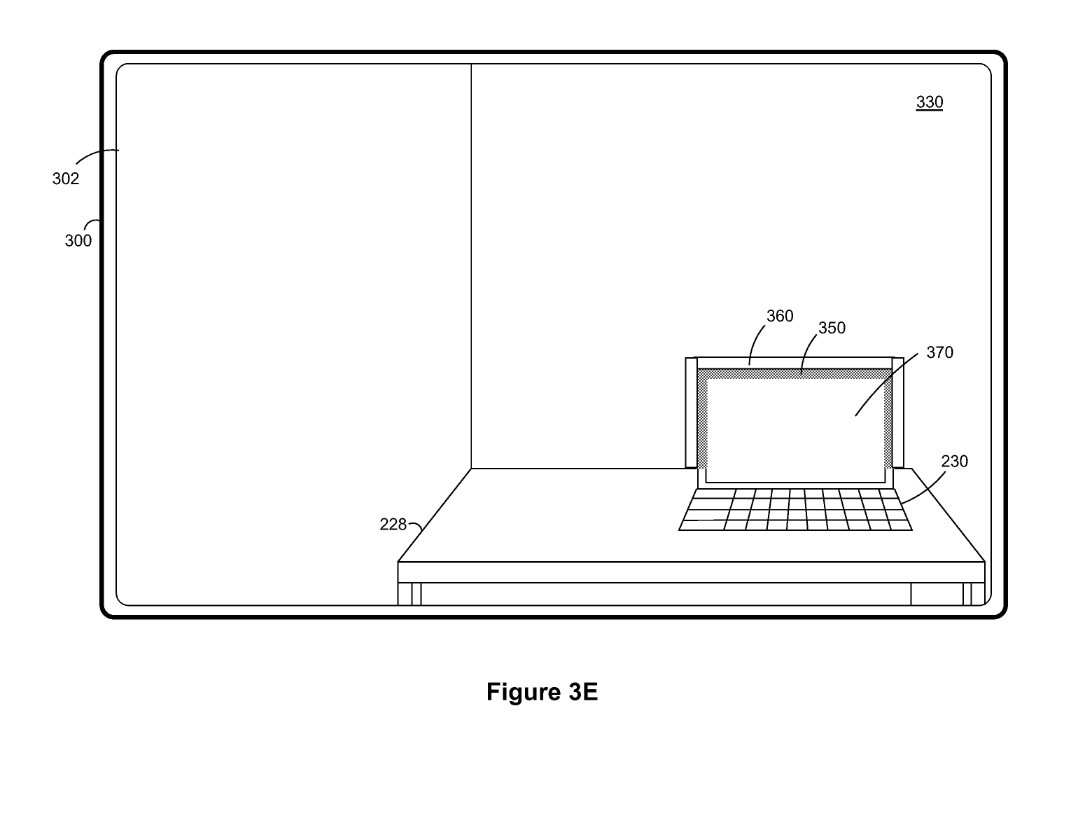

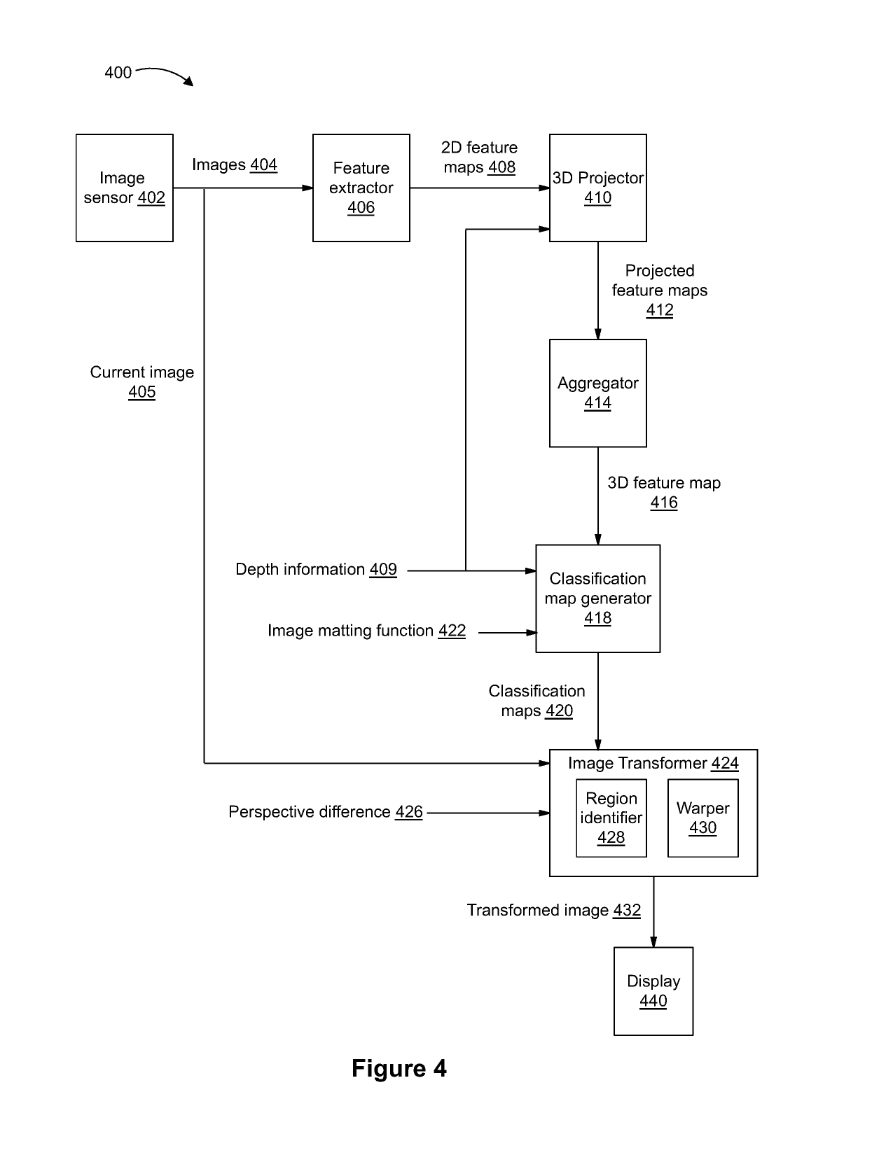

FIGS. 3A-3E are an example of an electronic device 300 generating classification maps according to various implementations. In some implementations, the electronic device 300 is similar to and adapted from the electronic device 100 described with reference to FIG. 1 or the electronic device 220 described with reference to FIG. 2. In some implementations, the electronic device 300 is similar to and adapted from an electronic device 400, which will be described with reference to FIG. 4. In some implementations, the electronic device 300 corresponds to an HMD with a display and an image sensor (e.g., a camera).

At a first time, the electronic device 300 captures, from a first perspective of the image sensor, a first image 310 of the physical environment 260, described with reference to FIG. 2. The first image 310 includes the representation 228 of the physical table 262 and the representation 230 of the physical laptop 264 from the first perspective of the image sensor. As illustrated in FIG. 3A, the electronic device 300 displays, on a display 302, the first image 310.

At a second time, the electronic device 300 captures, from a second perspective of the image sensor different from the first perspective, a second image 320 of the physical environment 260. The second image 320 includes the representation 228 of the physical table 262 and the representation 230 of the physical laptop 264 from the second perspective of the image sensor. As illustrated in FIG. 3B, the electronic device 300 displays, on the display 302, the second image 320.

At a third time, the electronic device 300 captures, from a third perspective of the image sensor different from the first and second perspectives, a third image 330 of the physical environment 260. The third image 330 includes the representation 228 of the physical table 262 and the representation 230 of the physical laptop 264 from the third perspective of the image sensor. As illustrated in FIG. 3C, the electronic device 300 displays, on the display 302, the third image 330.

In various circumstances, one or more of the images 310, 320, and 330 include distortion, due to the presence of the physical laptop 264 in the physical environment 260 relative to other portions (e.g., the back wall) of the physical environment 260. The distortion may result from occlusion caused by the physical laptop 264. For example, as illustrated in FIG. 3D, because the physical laptop 264 occludes a portion of the back wall of the physical environment 260, in the third image 330 there is distortion 340 around the outer edges of the screen of the representation 230 the physical laptop 264. The level of distortion may increase due to an increase in distance between the physical laptop 264 and the back wall of the physical environment 260. For example, the level of distortion may increase when the physical laptop 264 is moved to a position on the physical table 262 that is closer to the electronic device 300 and farther away from the back wall of the physical environment 260.

Thus, according to various implementations, an electronic device performs multi-layer image transforming to prevent or correct the distortion. For example, FIG. 4 illustrates an electronic device 400 configured to perform multi-layer image transformation.

The electronic device 400 includes an image sensor 402 to capture a plurality of images 404 of a physical environment (e.g., the first image 310, the second image 320, and the third image 330). In some implementations, each of the plurality of images 404 is associated with a distinct field-of-view of the image sensor 402 – e.g., from a distinct perspective of the image sensor 402.

In some implementations, the electronic device 400 includes a feature extractor 406. The feature extractor 406 generates a plurality of 2D feature maps 408 based on the plurality of images 404. For example, in some implementations, each of the plurality of 2D feature maps 408 characterizes a corresponding image of the plurality of images 404. A 2D feature map may have a lower resolution than a corresponding image, enabling lower latency and faster processing (e.g., real time processing) by downstream components of the electronic device 400, as described below. Moreover, a 2D feature map may indicate one or more object(s) and corresponding location(s) within a corresponding image. To that end, in some implementations, the feature extractor 406 performs instance segmentation or semantic segmentations on each of the plurality of images 404. For example, with reference to FIG. 3A, the feature extractor 406 generates a first 2D feature map that characterizes the first image 310, wherein the first 2D feature map semantically indicates a “table” and a “laptop,” and may also indicate respective locations of these objects within the first image 310. In some implementations, each of the plurality of 2D feature maps 408 is associated with (e.g., characterizes) a common feature of a physical environment. For example, with reference to FIGS. 3A-3C, the feature extractor 406 generates three 2D feature maps respectively associated with the first image the first image 310, the second image 320, and the third image 330, and each of the three 2D feature maps identifies the representation 230 of the physical laptop 264.

Referring back to FIG. 4, in some implementations, the electronic device 400 includes a 3D projector 410. The 3D projector 410 generates a respective plurality of projected feature maps 412 for the plurality of 2D feature maps 408. In some implementations, the respective plurality of projected feature maps 412 may correspond to a plurality of 3D point clouds. In some implementations, generating the respective plurality of projected feature maps 412 includes projecting, from 2D space to 3D space, each of the plurality of 2D feature maps 408. The projection may be based on a current perspective of the image sensor 402. In some implementations, the projection is based on one or more of keyframe intrinsics and depth information 409 (e.g., a depth map) characterizing the physical environment. In some implementations, projecting from the 2D space to the 3D space includes splatting each of the plurality of 2D feature maps 408, such as by performing a softmax splatting operation.

In some circumstances, the respective plurality of projected feature maps 412 may have holes, misalignment, and other artifacts – e.g., due low resolution pixel quantization. Accordingly, in some implementations, the electronic device 400 includes an aggregator 414 that aggregates the respective plurality of projected feature maps 412, to generate a (single) 3D feature map 416. To that end, in some implementations, the aggregator 414 includes a trained machine learning model that aggregates the respective plurality of projected feature maps 412. In some implementations, the aggregator 414 includes a rule-based system that aggregates the respective plurality of projected feature maps 412.

In some implementations, the electronic device 400 includes a classification map generator 418. The classification map generator 418 generates a plurality of classification maps 420 based at least in part on an image matting function 422. Each of the plurality of classification maps 420 may be associated with a distinct layer (e.g., depth) of the physical environment. For example, a first classification map corresponds to a foreground classification map associated with a foreground region of the 3D feature map 416, and a second classification map corresponds to a background classification map associated with a background region of the 3D feature map 416. To that end, in some implementations, the image matting function 422 identifies a combination of a foreground object and a background object in the 3D feature map 416. In some implementations, the classification map generator 418 also uses the depth information 409 to generate the plurality of classification maps 420. In some implementations, each of the plurality of classification maps 420 has a number of pixels equal to the number of pixels of a current image 405 of the plurality of image 404. To that end, in some implementations, the electronic device 400 performs upsampling, as will be described below. In some implementations, each of the plurality of classification maps 420 includes a plurality of pixels, and each pixel of the plurality of pixels indicates a respective set of channel values. In some implementations, each of the respective set of channel values includes a red channel value, a green channel value, and a blue channel value.

The electronic device 400 includes an image transformer 424. The image transformer 424 transforms the current image 405 of the plurality of image 404, based on the plurality of classification maps 420 and a perspective difference 426. The electronic device 400 captures the current image 405 from a current perspective of the image sensor 402.

The perspective difference 426 corresponds to a difference between the current perspective of the image sensor and a current perspective of a user of the electronic device 400. For example, with reference to FIG. 5 (described below), an image sensor 530 is offset from eyes 520 of a user according to a vertical offset 541 and a longitudinal offset 542.

In some implementations, the image transformer 424 includes a region identifier 428. The region identifier 428 identifies, using the plurality of classification maps 420, a foreground region of the current image 405 and a background region of the current image 405. To that end, in some implementations, identifying the foreground region of the current image 405 and the background region of the current image 405 includes performing per-pixel dot product operations between the current image 405 and each of the plurality of classification maps 420. For example, with reference to FIG. 3E, the electronic device 300 identifies a foreground region 350 of the third image 330, wherein the foreground region 350 corresponds to outer edges of the screen of the representation 230 of the physical laptop 264. Continuing with this example, the electronic device 300 identifies a background region 360 of the third image 330, wherein the background region 360 corresponds to a representation of a portion of the back wall of the physical environment 260. The portion of the back wall surrounds the outer edges of the screen of the physical laptop 264 in xy space of the physical environment 260, but has a greater z value (greater depth) than the screen of the physical laptop 264 in the physical environment 260. This depth discontinuity between the foreground region 350 and the background region 360 can result in distortions in some circumstances. Thus, according to various implementations, the electronic device 400 transforms the foreground region 350 and the background region 360 via a warper 430, as is described below. In some implementations, the region identifier 428 also identifies, using the plurality of classification maps 420, an ignore region 370, as illustrated in FIG. 3E. The ignore region 370 corresponds to an inner portion of the screen of the representation 230 of the physical laptop 264 – e.g., inside of the foreground region 350. For example, identifying the ignore region 370 includes determining that the ignore region 370 is sufficiently far away from (in xy space) the depth discontinuity characterizing the foreground region 350 and the background region 360. As will be described below, in some implementations, the ignore region 370 is ignored by the warper 430. The foreground region 350, the background region 360, and the ignore region 370 are each illustrated in FIG. 3E for purely explanatory purposes, and may or may not be displayed on the display 302.

Referring back to FIG. 4, the image transformer 424 includes a warper 430. The warper 430 transforms (e.g., warps) the foreground region 350 and the background region 360 of the current image 405 based on the perspective difference 426, to generate a transformed image 432. In some implementations, in addition to warping the current image 405, transforming the current image 405 also includes hole filling the current image 405 based at least in part on the perspective difference 426. In some implementations, the warper 430 foregoes transforming (e.g., warping) the ignore region 370, thereby reducing processor utilization. The transformed image 432 is displayable on a display 440 of the electronic device 400. For example, the display 440 displays the includes the transformed foreground region 350, the transformed background region 360, and untransformed (e.g., image-captured) ignore region 370.

FIG. 5 illustrates an example scenario 500 related to capturing an image of an environment and displaying the captured image in accordance with some implementations. A user wears an electronic device including a display 510 and an image sensor 530. The image sensor 530 captures an image of a physical environment and the display 510 displays the image of the physical environment to the eyes 520 of the user. The image sensor 530 has a perspective that is offset vertically from the perspective of the user (e.g., where the eyes 520 of the user are located) by a vertical offset 541. Further, the perspective of the image sensor 530 is offset longitudinally from the perspective of the user by a longitudinal offset 542. Further, in various implementations, the perspective of the image sensor 530 is offset laterally from the perspective of the user by a lateral offset (e.g., into or out of the page in FIG. 5).

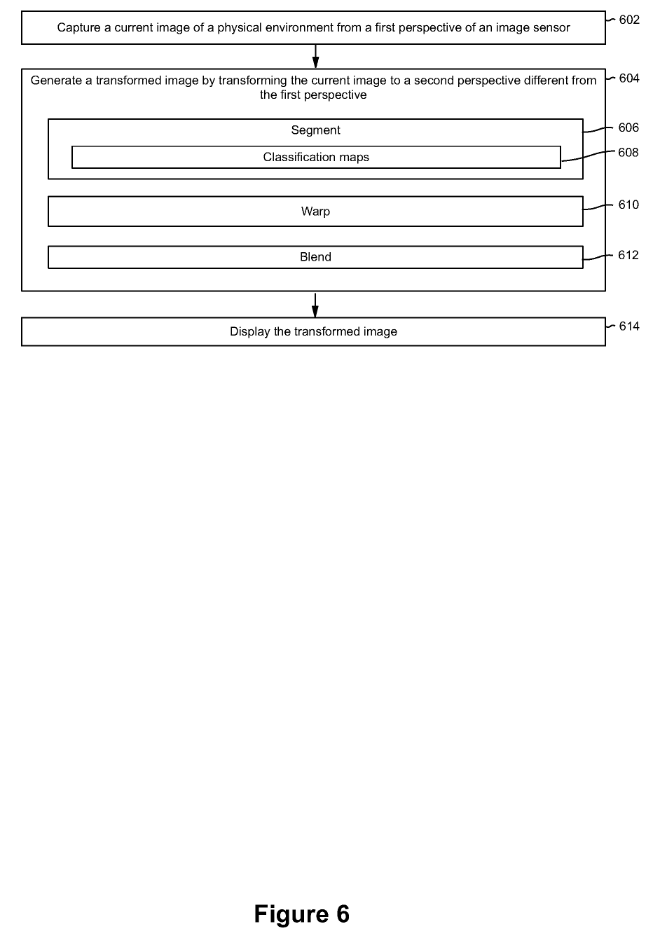

FIG. 6 is a first example of a flow diagram of a method 600 of performing multi-layer image transforming according to various implementations. In various implementations, the method 600 or portions thereof are performed by an electronic device including one or more processors, a non-transitory memory, an image sensor, and a display. For example, the electronic device 300 described with reference to FIGS. 3A-3E performs the method 600. As another example, the electronic device 400 described with reference to FIG. 4 performs the method 600. In various implementations, the method 600 or portions thereof are performed by a head-mountable device (HMD). In some implementations, the method 600 is performed by processing logic, including hardware, firmware, software, or a combination thereof. In some implementations, the method 600 is performed by a processor executing code stored in a non-transitory computer-readable medium (e.g., a memory). In various implementations, some operations in method 600 are, optionally, combined and/or the order of some operations is, optionally, changed.

As represented by block 602, the method 600 includes capturing a current image of a physical environment from a first perspective of an image sensor. For example, with reference to FIG. 4, the image sensor 402 captures the current image 405. In some implementations, capturing the current image occurs after obtaining a 3D feature map (e.g., the 3D feature map 416 in FIG. 4), which is based on previously captured images.

As represented by block 604, the method 600 includes generating a transformed image by transforming the current image to a second perspective different from the first perspective. To that end, as represented by block 606, the method 600 includes segmenting the current image into first and second layers based on depth information regarding the physical environment (e.g., the depth information 409 in FIG. 4). In some implementations, the first layer corresponds to a foreground layer, and the second layer corresponds to a background layer. For example, with reference to FIG. 3E, the foreground layer corresponds to the foreground region 350 of the third image 330, and the background layer corresponds to the background region 360 of the third image 330. As one example, with reference to FIG. 3A, the depth information indicates a first depth value associated with the representation 230 of the physical laptop 264, and indicates a second (larger) depth value associated with a representation of the back wall of the physical environment 260.

As another example, in some implementations and as represented by block 608, the depth information is indicated by a plurality of classification maps. As one example, generation of the plurality of classification maps 420 is described with reference to FIG. 4. For example, the plurality of classification maps indicates a foreground classification map and a background classification map, and the method 600 includes applying the foreground and background classification maps to the current image. Continuing with this example, the method 600 may include performing per-pixel dot product operations between the current image and each of the background classification map and the foreground classification map, in order to segment the current image into a first layer (background layer) and a second layer (foreground layer).

As represented by block 610, generating the transformed image includes warping the first layer to generate a first warped layer, and warping the second layer to generate a second warped layer. In some implementations, warping the first and second layers is based on based on a difference between the first perspective of the image sensor and a current perspective of a user of the electronic device. For example, with reference to FIG. 5, the difference corresponds to one or more of the vertical offset 541 or the longitudinal offset 542.

As represented by blocks 612 and 614, generating the transformed image includes blending (e.g., combining) the first warped layer with the second warped layer, and displaying the output of the blending on a display.

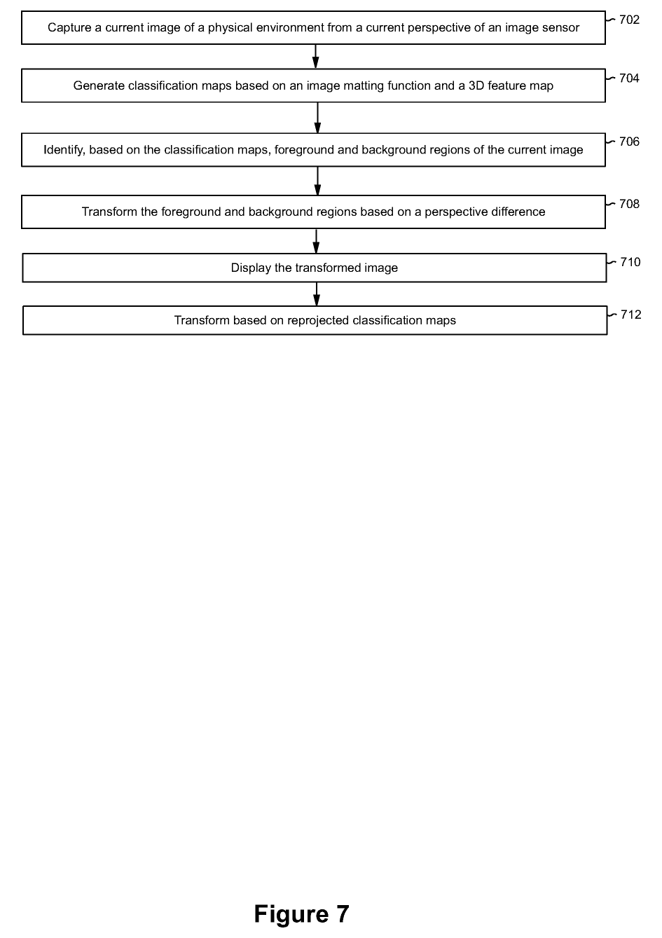

FIG. 7 is a second example of a flow diagram of a method 700 of performing multi-layer image transforming according to various implementations. In various implementations, the method 700 or portions thereof are performed by an electronic device including one or more processors, a non-transitory memory, an image sensor, and a display. For example, the electronic device 300 described with reference to FIGS. 3A-3E performs the method 700. As another example, the electronic device 400 described with reference to FIG. 4 performs the method 700. In various implementations, the method 700 or portions thereof are performed by a head-mountable device (HMD). In some implementations, the method 700 is performed by processing logic, including hardware, firmware, software, or a combination thereof. In some implementations, the method 700 is performed by a processor executing code stored in a non-transitory computer-readable medium (e.g., a memory). In various implementations, some operations in method 700 are, optionally, combined and/or the order of some operations is, optionally, changed.

As represented by block 702, the method 700 includes capturing a current image of a physical environment from a current perspective of the image sensor, such as described with reference to block 602 of FIG. 6.

As represented by block 704, the method 700 includes generating a plurality of classification maps based on an image matting function and 3D feature map associated with the physical environment. For example, with reference to FIG. 4, the electronic device 400 generates the 3D feature map 416 based on the respective plurality of projected feature maps 412. In some implementations, each of the respective plurality of projected feature maps is associated with a corresponding 2D feature map, which itself is based on a captured image from a respective perspective of the image sensor. For example, the 3D feature map is based on a plurality of 2D feature maps respectively associated with a plurality of distinct perspectives of the image sensor. Further details regarding obtaining or generating the 3D feature map are provided with regards to FIG. 4. In some implementations, generating the the plurality of classification maps is further based on depth information regarding the physical environment (e.g., the depth information 409 in FIG. 4).

In some implementations, the plurality of classification maps includes a foreground classification map, a background classification map, and an ignore classification map. Whereas the foreground and background classification maps respectively indicate foreground and background portions of the physical environment to be targeted for warping, the ignore classification map indicates a portion of the physical environment that is not to be targeted for warping. In some implementations, the plurality of classification maps also includes an in-between map, wherein the in-between map is associated with a respective depth that is greater than a foreground depth associated with the foreground classification map and less than a background depth associated with the background classification map.

In some implementations, generating the plurality of classification maps includes generating a plurality of intermediate classification maps by applying the image matting function to the 3D feature map, and upsampling the plurality of intermediate classification maps to generate the plurality of classification maps. The plurality of intermediate classification maps may be lower resolution than images captured by the image sensor. In some implementations, the upsampling is performed via bilinear upsampling, which is computationally inexpensive. The upsampling may be based on a resolution associated with the current image, such that the result of the upsampling - the plurality of classification maps – has a resolution that is within a threshold of the resolution of the current image.

As represented by block 706, the method 700 includes identifying, using the plurality of classification maps, a foreground region of the current image and a background region of the current image. To that end, in some implementations, the method 700 includes applying the plurality of classification maps to the current image. For example, the method 700 includes performing per-pixel dot product operations between the current image and each of the plurality of classification maps. In some implementations, the method 700 includes applying the foreground classification map to the current image to identify the foreground region of the current image, and applying the background classification map to the current image to identify the background region of the current image. As one example, with reference to FIG. 3E, the electronic device 300 identifies the foreground region 350 of the third image 330, wherein the foreground region 350 corresponds to outer edges of the screen of the representation 230 of the physical laptop 264. Continuing with this example, the electronic device 300 identifies the background region 360 of the third image 330, wherein the background region 360 corresponds to a representation of a portion of the back wall of the physical environment 260. In some implementations, the method 700 includes identifying, using the plurality of classification maps, an ignore region of the current image, which may be ignored during image transformation (e.g., image warping). As one example, with reference to FIG. 3E, the electronic device 300 identifies the ignore region 370 of the third image 330.

As represented by block 708, the method 700 includes transforming the foreground and background regions of the current image based on a difference between the current perspective of the image sensor and a current perspective of a user of the electronic device. For example, with reference to FIG. 5, the difference corresponds to one or more of the vertical offset 541 or the longitudinal offset 542. Transforming may include a combination of warping and hole filing. In some implementations, the method 700 includes maintaining (e.g., not transforming) the ignore region of the current image. In some implementations, the method 700 includes transforming (e.g., warping) the ignore region according to another (e.g., not multi-layer) warping function. For example, the method 700 includes warping the ignore region according to a simpler (e.g., less computationally expensive) warping function.

As represented by block 710, the method 700 includes displaying the transformed image on the display. In some implementations, displaying the transformed image includes displaying the transformed background and foreground regions, while displaying the maintained (e.g., untransformed) ignore region. In some implementations, displaying the transformed image includes displaying the transformed background region, the transformed foreground region, and the transformed ignore region.

As represented by block 712, in some implementations, the method 700 includes transforming a subsequently captured image based on reprojected classification maps. To that end, the method 700 includes capturing a subsequent image of a physical environment from a subsequent perspective of the image sensor, reprojecting the plurality of classification maps based on the subsequent perspective of the image sensor, and transforming the subsequent image of the physical environment based on the reprojected plurality of classification maps. For example, the current image is captured from the current perspective of the image sensor at a first time (e.g., as represented by block 702), and the subsequent image is captured from the subsequent perspective of the image sensor at a second time later than the first time. In some implementations, reprojecting the plurality of classification maps is based on the depth information regarding the physical environment (e.g., a depth map), enabling a six degrees of freedom (6-DOF) reprojection. Reprojection enables the plurality of classification maps to be generated once (e.g., as represented by block 704), and used for several frames in the future, thereby reducing resource utilization that would otherwise be used to generate additional classification maps. Moreover, generation of additional classification maps is time consuming, and the additionally generated classification maps may be outdated for application to the subsequent image. In some implementations, the method 700 includes displaying the transformed subsequent image on the display.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or systems stored in a memory or other non-transitory computer-readable storage medium or device. The various functions disclosed herein may be implemented in such program instructions, although some or all of the disclosed functions may alternatively be implemented in application-specific circuitry (e.g., ASICs or FPGAs or GP-GPUs) of the computer system. Where the computer system includes multiple computing devices, these devices may be co-located or not co-located. The results of the disclosed methods and tasks may be persistently stored by transforming physical storage devices, such as solid-state memory chips and/or magnetic disks, into a different state.

Various processes defined herein consider the option of obtaining and utilizing a user’s personal information. For example, such personal information may be utilized in order to provide an improved privacy screen on an electronic device. However, to the extent such personal information is collected, such information should be obtained with the user’s informed consent. As described herein, the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well-established, user-accessible, and recognized as in compliance with or above governmental/industry standards. Moreover, these parties will not distribute, sell, or otherwise share such information outside of any reasonable and legitimate purposes.

Users may, however, limit the degree to which such parties may access or otherwise obtain personal information. For instance, settings or other preferences may be adjusted such that users can decide whether their personal information can be accessed by various entities. Furthermore, while some features defined herein are described in the context of using personal information, various aspects of these features can be implemented without the need to use such information. As an example, if user preferences, account names, and/or location history are gathered, this information can be obscured or otherwise generalized such that the information does not identify the respective user.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various implementations described above can be combined to provide further implementations. Accordingly, the novel methods and systems described herein may be implemented in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method comprising:
at an electronic device including one or more processors, a non-transitory memory, an image sensor, and a display:
capturing a current image of a physical environment from a current perspective of the image sensor;
generating a plurality of classification maps based on an image matting function and a three-dimensional (3D) feature map associated with the physical environment;
identifying, using the plurality of classification maps, a foreground region of the current image and a background region of the current image;
transforming the foreground and background regions of the current image based on a difference between the current perspective of the image sensor and a current perspective of a user of the electronic device; and
displaying the transformed image on the display.

2. The method of claim 1, wherein the plurality of classification maps includes a foreground classification map, a background classification map, and an ignore classification map.

3. The method of claim 2, wherein the plurality of classification maps also includes an in-between map, wherein the in-between map is associated with a respective depth that is greater than a foreground depth associated with the foreground classification map and less than a background depth associated with the background classification map.

4. The method of claim 1, further comprising:
identifying, using the plurality of classification maps, an ignore region of the current image; and
maintaining the ignore region of the current image by not transforming the ignore region, wherein displaying the transformed image includes displaying the maintained ignore region.

5. The method of claim 1, wherein the 3D feature map is based on a plurality of two-dimensional (2D) feature maps respectively associated with a plurality of distinct perspectives of the image sensor.

6. The method of claim 5, wherein obtaining the 3D feature map includes projecting, into 3D space, each of the plurality of 2D feature maps to generate a respective plurality of projected feature maps, wherein the projection is based on the current perspective of the image sensor.

7. The method of claim 6, wherein obtaining the 3D feature map includes aggregating the respective plurality of projected feature maps to generate the 3D feature map.

8. The method of claim 5, wherein obtaining the 3D feature map includes:
capturing a plurality of images of the physical environment from the distinct plurality of perspectives of the image sensor;
identifying a feature of the physical environment within each of the plurality of images; and
generating the plurality of 2D feature maps based on identification of the feature.

9. The method of claim 5, wherein each of the plurality of 2D feature maps is associated with a common feature of the physical environment.

10. The method of claim 9, wherein the common feature corresponds to an edge of a physical object of the physical environment.

11. The method of claim 1, wherein generating the plurality of classification maps includes:
generating a plurality of intermediate classification maps by applying the image matting function to the 3D feature map; and
upsampling the plurality of intermediate classification maps to generate the plurality of classification maps.

12. The method of claim 1, wherein each of the plurality of classification maps includes a plurality of pixels, and wherein each pixel of the plurality of pixels includes a respective set of channel values.

13. The method of claim 12, wherein each of the respective set of channel values includes a red channel value, a green channel value, and a blue channel value.

14. The method of claim 1, wherein generating the plurality of classification maps is further based on a depth information regarding the physical environment.

15. The method of claim 1, further comprising:
capturing a subsequent image of a physical environment from a subsequent perspective of the image sensor;
reprojecting the plurality of classification maps based on the subsequent perspective of the image sensor; and
transforming the subsequent image of the physical environment based on the reprojected plurality of classification maps.

16. The method of claim 15, wherein reprojecting the plurality of classification maps includes performing a six degrees of freedom (6-DOF) reprojection using depth information regarding the physical environment.

17. An electronic device comprising:
one or more processors;
a non-transitory memory;
an image sensor; and
a display; and
one or more programs, wherein the one or more programs are stored in the non-transitory memory and configured to be executed by the one or more processors, the one or more programs including instructions for:
capturing a current image of a physical environment from a current perspective of the image sensor;
generating a plurality of classification maps based on an image matting function and 3D feature map associated with the physical environment;
identifying, using the plurality of classification maps, a foreground region of the current image and a background region of the current image;
transforming the foreground and background regions of the current image based on a difference between the current perspective of the image sensor and a current perspective of a user of the electronic device; and
displaying the transformed image on the display.

18. The electronic device of claim 17, wherein the one or more programs further include instructions for:
identifying, using the plurality of classification maps, an ignore region of the current image; and
maintaining the ignore region of the current image by not transforming the ignore region, wherein displaying the transformed image includes displaying the maintained ignore region.

19. The electronic device of claim 17, wherein the 3D feature map is based on a plurality of two-dimensional (2D) feature maps respectively associated with a plurality of distinct perspectives of the image sensor.

20. A non-transitory memory storing one or more programs, which, when executed by one or more processors of an electronic device including a first display and an image sensor, cause the electronic device to:
capture a current image of a physical environment from a current perspective of the image sensor;
generate a plurality of classification maps based on an image matting function and 3D feature map associated with the physical environment;
identify, using the plurality of classification maps, a foreground region of the current image and a background region of the current image;
transform the foreground and background regions of the current image based on a difference between the current perspective of the image sensor and a current perspective of a user of the electronic device; and
display the transformed image on the display.
